(19) United States
(12) Patent Application Publication
(10) Pub. No.: US 2013/0033122 A1
(43) Pub. Date: Feb. 7, 2013

(54) METHOD AND APPARATUS FOR DRIVING A STAGE USING ANGLED ACTUATORS FOR PUSHPOINT MATCHING

(71) Applicant: Michael B. Binnard, Belmont, CA (US)

(72) Inventor: Michael B. Binnard, Belmont, CA (US)

(21) Appl. No.: 13/560,787

(22) Filed: Jul. 27, 2012

Related U.S. Application Data
(60) Provisional application No. 61/512,917, filed on Jul. 29, 2011.

(51) Int. Cl. H02K 41/02

(52) U.S. Cl. 310/12.06

(57) ABSTRACT

According to one aspect, an apparatus includes a stage and a first actuator. The stage has a stage center of gravity, and a first axis passes, e.g., horizontally, though the stage center of gravity. The first actuator is offset from the stage center of gravity relative to a second axis and arranged to generate a first force. The second axis is perpendicular to the first axis, and the first actuator is oriented to allow the first force to act through the stage center of gravity to drive the stage.

### CROSS REFERENCE TO RELATED APPLICATION

The present application claims benefit under 35 U.S.C. §119(e) of U.S. Provisional Patent Application No. 61/512,917, entitled “Angled Actuators for Pushpoint Matching,” filed Jul. 29, 2011, which is incorporated herein by reference in its entirety for all purposes.

### BACKGROUND OF THE INVENTION

1. Field of the Invention

The present invention relates generally to equipment used in semiconductor processing. More particularly, the present invention relates positioning actuators that drive a stage relative to a horizontal axis such that the actuators are offset from a stage center of gravity relative to a horizontal axis and such that the actuators are rotated at an angle that points through the center of gravity of a stage to substantially ensure that acceleration forces act through the center of gravity of the stage.

2. Description of the Related Art

In stage devices, actuators that provide stage acceleration, e.g., XY actuators, are oriented to produce horizontal forces. Orienting actuators to produce horizontal forces through a center of gravity of a stage allows the stage to be driven by the actuators while minimizing pitching moments. That is, orienting actuators such that actuator pushpoints effectively match the center of gravity of a stage generally allows the stage to be driven substantially without causing significant pitching moments.

In some situations, matching an actuator pushpoint with a center of gravity of a stage such that the actuator and the center of gravity of the stage are aligned along a horizontal axis, e.g., at the same height, may be difficult. For example, constraints on the design of a stage apparatus may render it difficult to position an actuator and a stage center of gravity along the same horizontal axis and, hence, to match an actuator pushpoint with the center of gravity of a stage with respect to a horizontal axis. As a result, relatively significant pitching moments may arise when a stage is driven by an actuator with a pushpoint that is not effectively matched with the center of gravity of the stage. Pitching moments may have an adverse affect on the performance of a stage and, thus, also have an adverse effect on the quality of any devices formed using the stage.

### SUMMARY OF THE INVENTION

The present invention pertains to stage design that allows a stage to be driven by actuators through the center of gravity of the stage when the actuator pushpoints are not matched to the height of the center of gravity of the stage. According to one aspect, an apparatus includes a stage and a first actuator. The stage has a stage center of gravity, and a first axis passes horizontally though the stage center of gravity. The first actuator is offset from the stage center of gravity relative to a second axis and arranged to generate a first force. The second axis is perpendicular to the first axis, and the first actuator is oriented to allow the first force to act through the stage center of gravity to drive the stage.

According to another aspect, an apparatus includes a stage, a first support arrangement, and a first actuator. The stage translates with respect to at least one horizontal axis, and has a center of gravity. The first support arrangement is configured to support the stage with respect to a vertical axis, and the first actuator is configured to drive the stage with respect to the horizontal axis by applying a first actuator force through the center of gravity. The first actuator force is applied at an angle with respect to the horizontal axis. In one embodiment, the first actuator is a variable-reluctance actuator such as an E-core actuator, a voice coil motor, or a linear motor.

In accordance with still another aspect, a method of driving a stage along a horizontal axis using a first actuator includes generating a first force and a second force. The stage has stage center of gravity, and the first actuator is offset from the stage center of gravity relative to a vertical axis. The stage is supported relative to the vertical axis by a support arrangement. The first force is generated by the first actuator to drive the stage along the horizontal axis, and the first force is applied to the stage through the stage center of gravity and at an angle with respect to the horizontal axis. The second force is generated by the support arrangement, and is applied to the stage along the vertical axis.

### BRIEF DESCRIPTION OF THE DRAWINGS

The disclosure will be readily understood by the following detailed description in conjunction with the accompanying drawings, in which:

FIG. 1A is a diagrammatic representation of a stage arrangement with a stage that is driven in at least one horizontal direction using a plurality of actuators that are offset from the center of gravity of the stage in a vertical direction but arranged to apply forces through the center of gravity of the stage in accordance with an embodiment.

FIG. 1B is a diagrammatic representation of a stage arrangement, e.g., stage arrangement 100 of FIG. 1A, that shows forces associated with driving a stage through a stage center of gravity in accordance with an embodiment.

FIG. 2 is a diagrammatic representation of a stage arrangement in which the components of forces associated with driving a stage through a stage center of gravity are depicted in accordance with an embodiment.

FIG. 3 is a schematic diagram representation of an actuator oriented at an angle with respect to a horizontal axis, and arranged to drive a stage in a horizontal direction from a position below a center of gravity of the stage in accordance with an embodiment

FIG. 4 is a diagrammatic representation of a duty cycle associated with a stage in accordance with an embodiment.

FIG. 5 is a diagrammatic representation of a photolithography apparatus in accordance with an embodiment of the present invention.

FIG. 6 is a process flow diagram which illustrates the steps associated with fabricating a semiconductor device in accordance with an embodiment of the present invention.

FIG. 7 is a process flow diagram which illustrates the steps associated with processing a wafer, i.e., step 1113 of FIG. 6, in accordance with an embodiment of the present invention.

### DETAILED DESCRIPTION OF THE EMBODIMENTS

Example embodiments of the present disclosure are discussed below with reference to the various figures. However, those skilled in the art will readily appreciate that the detailed description given herein with respect to these figures is for explanatory purposes, as the invention extends beyond these embodiments.

Ensuring that acceleration forces provided by actuators to drive a stage through a center of gravity of the stage reduces the likelihood that pitching moments may arise. As pitching moments may adversely affect the performance of a stage apparatus, substantially minimizing pitching moments is desirable.

In general, to accommodate overall constraints, e.g., design constraints, associated with an overall stage apparatus, actuators that provide horizontal acceleration to a stage may not be positioned at the same height as the center of gravity of the stage. Instead, the actuators may be located at a distance below the center of gravity of the stage or at a distance above the center of gravity of the stage. By rotating the actuators which are offset from the center of gravity of a stage relative to a vertical axis, the pushpoints of the actuators may drive the stage through the center of gravity. It should be apparent to those skilled in the art that in appropriate applications, embodiments of the present invention may be operated in a rotated configuration in which actuators are providing a vertical force and are offset horizontally from the stage center of gravity.

In one embodiment, actuators used to provide a stage with acceleration by driving the stage through a stage center of gravity relative to a horizontal axis are not positioned at the same height as the stage center of gravity and may, instead, be offset from the stage center of gravity by an offset amount. Such actuators may be oriented at an angle, e.g., rotated at an angle, such that the lines along which actuator forces act, e.g., pushpoints of the actuators, are oriented through the center of gravity of the stage. As such, a stage may be driven through its center of gravity by actuators, e.g., acceleration actuators, which are not located at the same height as the center of gravity when the actuators are effectively tilted or angled substantially without creating undesirable pitching moments.

By allowing actuators positioned below or above a stage center of gravity relative to a vertical axis to drive a stage in at least one horizontal direction, flexibility in the positioning of the actuators may be achieved while substantially minimizing pitching moments. The ability to orient actuators in a rotated position such that the pushpoints of the actuators are effectively aligned with a stage center of gravity allows a stage to be driven substantially without causing significant moments. Thus, actuators may be positioned at an offset form a stage center of gravity relative to a vertical axis, while providing acceleration forces relative to a horizontal axis.

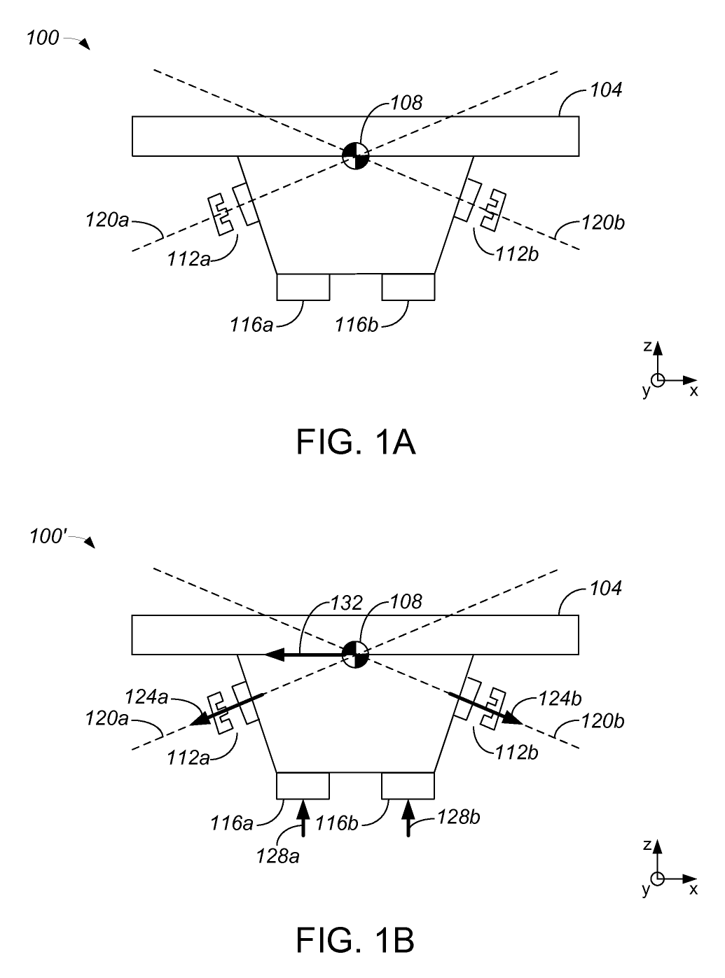

Referring initially to FIG. 1A, a stage that is driven by acceleration actuators which are not at the same height as a center of gravity of the stage will be described in accordance with an embodiment. A stage apparatus includes a stage 104 which has a center of gravity 108. Actuators 112a, 112b which drive stage 104 are offset from center of gravity with respect to a vertical axis, i.e., a z-axis. Although actuators 112a, 112b are shown as being positioned below center of gravity 108 with respect to a vertical axis, it should be understood that actuators 112a, 112b may instead be positioned above center of gravity 108 with respect to the vertical axis. In addition, it should be appreciated that an overall assembly may be rotated with respect to gravity such that a z-axis is not vertical.

Actuators 112a, 112b are arranged to provide a horizontal acceleration force that allows stage 104 to translate along a horizontal axis, e.g., an x-axis. Additionally, there may be other actuators (not shown) configured to provide acceleration forces to translate stage 104 along a second horizontal axis, e.g., a y-axis. Although actuators 112a, 112b are shown as being E-core actuators, it should be appreciated that actuators 112a, 112b are not limited to being E-core actuators. In addition to being E-core actuators, actuators 112a, 112b may also be, but are not limited to being, other types of variable-reluctance actuators, linear motors, and voice coil motors (VCMs). Actuators 112a, 112b are rotated, or otherwise oriented at an angle with respect to at least one horizontal axis, e.g., the x-axis, such that forces generated by actuators 112a, 112b effectively act through center of gravity 108. As shown, actuator 112a is aligned to provide a force (not shown) along a line or line of action 120a, and actuator 112b is aligned to provide a force (not shown) along a line or line of action 120b.

Support arrangements 116a, 116b are arranged to provide a vertical control force, i.e., force that acts along the z-axis. The vertical control force generated by support arrangements 116a, 116b effectively compensates for a vertical component of forces generated by actuators 112a, 112b. Support arrangements 116a, 116b may be actuators, e.g., VCMs, or any other suitable components that provide a vertical control force, e.g., air springs that have air pressure which acts with respect to the z-axis. In one embodiment, support arrangements 116a, 116b may include VCMs and “antigravity” or “weight-canceller” devices that are arranged to reduce the heat load of the VCMs.

FIG. 1B is a diagrammatic representation stage arrangement 100 of FIG. 1A that illustrates forces associated with driving stage 104 through stage center of gravity 108 in accordance with an embodiment. Within a stage arrangement 100′, a force 124a generated by actuator 112a acts along line 120a, while a force 124b generated by actuator 112b acts along line 120b. Force 128a and force 128b are generated by support arrangement 116a and support arrangement 116b, respectively, and act with respect to a vertical direction, i.e., a z-axis.

The magnitude of forces 124a, 124b is such that a desired force 132 may be generated that drives stage 104 through center of gravity 108. The magnitude of forces 128a, 128b balances at least vertical components of forces 124a, 124b. Force 132 allows stage 104 to accelerate. The magnitudes of forces 124a, 124b and the magnitudes of forces 128a, 128b are generally selected to be sufficient to provide force 132. That is, forces 124a, 124b and force 128a, 128b are typically selected to provide a desired amount of acceleration.

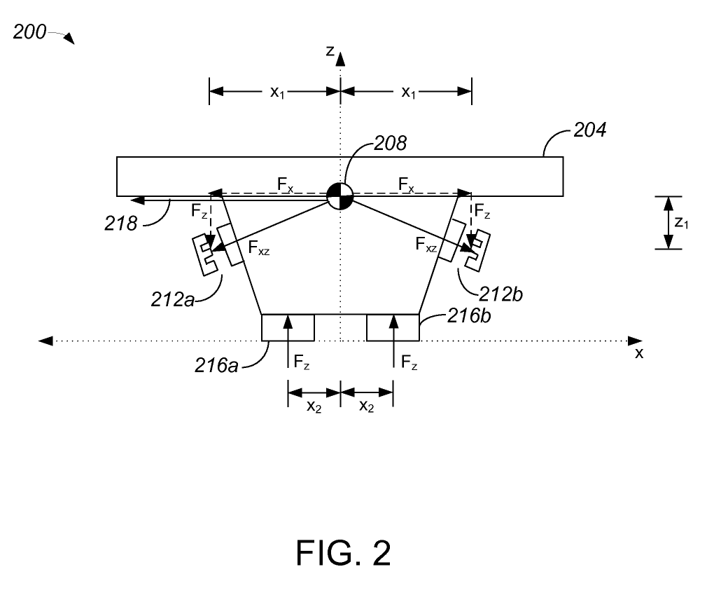

When actuator 112a and actuator 112b create force 124a and force 124b, respectively, to accelerate stage 104, in addition to producing components of forces 124a, 124b that act with respect to a horizontal direction, components of forces 124a, 124b that act with respect to a vertical direction are also produced. FIG. 2 is a diagrammatic representation of a stage arrangement in which the components of forces associated with driving a stage through a stage center of gravity are depicted in accordance with an embodiment. A stage arrangement 200 includes a stage 204 that is arranged to be accelerated in an x-direction, i.e., along an x-axis, using forces generated by rotated actuators 212a, 212b. Actuators 212a, 212b, which are offset from a stage center of gravity 208 by a distance z₁ relative to a z-axis, and rotated with respect to the x-axis, generate forces that act through stage center of gravity 208. Actuators 212a, 212b are each positioned at a distance x₁ from stage center of gravity 208 along the x-axis.

As shown, actuator 212a generates a force F_{xz} that has a force component Fₓ relative to the x-axis and a force component Fₓ relative to the z-axis. Similarly, actuator 212b generates a force F_{xz} that has a force component Fₓ relative to the x-axis and a force component F_{z} relative to the z-axis. Depending on the desired trajectory for stage 204, is possible that only one actuator 212a, 212b may be generating force F_{xz} at a given time, or two or more actuators 212a, 212b may be generating forces to produce a desired net force in an arbitrary direction. In the embodiment shown, force components F_{z} are generally downward components of force F_{xz}, and are compensated by forces F_{z} that are generated by support arrangements 216a, 216b to effectively push up on stage 204. That is, support arrangements 216a, 216b generated compensating forces F_{z}. In one embodiment, support arrangements 216a, 216b may be VCMs and/or air springs. It should be appreciated, however, that support arrangements 216a, 216b are not limited to being VCMs and/or air springs.

In general, a vector sum of forces F_{xz} and forces F_{z} generated by support arrangements 216a, 216b results in a desired acceleration 218 of stage 204 along the x-axis. Forces F_{z} generated by support arrangements 216a, 216b may be expressed as follows:

$${F}_{z} = \frac{{F}_{x} {z}_{1}}{{x}_{1}}$$

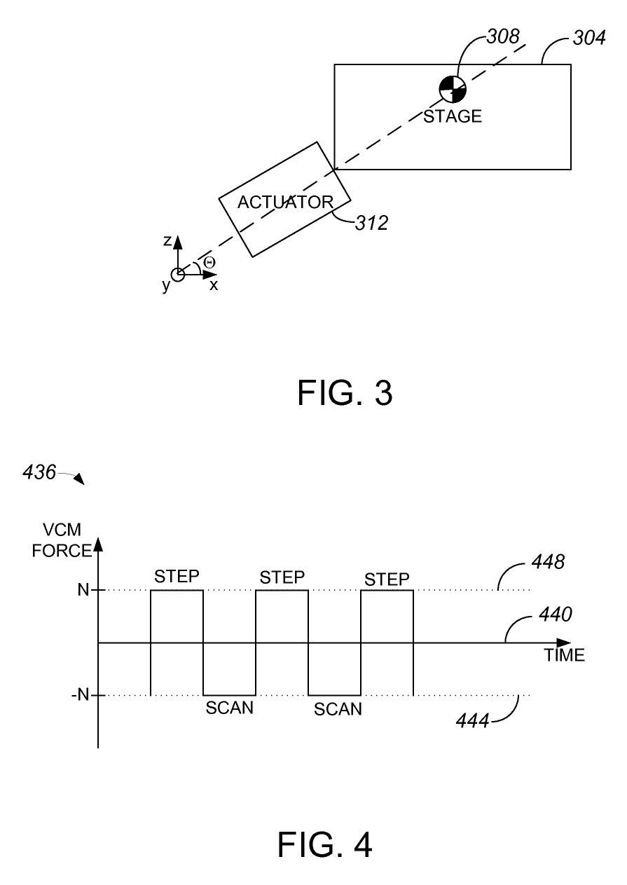

In general, an actuator which is offset from a stage center of gravity relative to a vertical direction is rotated with respect to at least one horizontal axis. The rotation of the actuator enables the actuator to generate a force which acts through the center of gravity of the stage. FIG. 3 is a schematic representation of an actuator oriented at an angle with respect to a horizontal axis, and arranged to drive a stage in a horizontal direction from a position below a center of gravity of the stage in accordance with an embodiment. An actuator 312 is positioned below a center of gravity 308 of a stage 304 relative to a vertical axis, i.e., a z-axis. Actuator 312 is rotated at an angle θ from a horizontal axis, e.g., an x-axis as shown. Therefore, a force (not shown) generated by actuator 312 acts at an angle θ from the horizontal axis. Angle θ is selected such that a force (not shown) generated by actuator 312 acts through center of gravity 308.

The value of angle θ may vary widely. For example, angle θ may generally have any suitable value that is greater than zero degrees and less than approximately ninety degrees. It should be appreciated that the value of angle θ may be selected based on any number of factors including, but not limited to including, a distance of actuator 312 from center of gravity 308 relative to a vertical axis, a distance of actuator 312 from center of gravity 308 relative to a horizontal axis, and the configuration of actuator 312.

A stage arrangement which includes rotated actuators may generally be used in a lithography apparatus. Often, when a lithography apparatus is in use, a stage that is part of the lithography apparatus and carries a wafer accelerates, or steps, approximately half of the time. When a stage is not accelerating, the wafer carried by the stage is being exposed, e.g., the stage is scanning or is substantially stationary.

An antigravity or weight-canceller device may be implemented to support at least a portion of the stage weight in a direction along a z-axis. Typically, in conventional systems, when a stage arrangement or assembly contains an antigravity or weight-canceller device to support the stage weight, the antigravity or weight-canceller force may be set to substantially balance the static weight of the stage. In one embodiment, if vertical forces from rotated actuators are known to primarily generate downward forces, the setpoint of an antigravity or weight-canceller device may be biased to a larger value, e.g., the setpoint of the antigravity device may be adjusted to counteract a portion of the vertical actuator forces in addition to the static weight of the state. In this way, an antigravity or weight-canceller device may be biased to reduce a heat load associated with a VCM or another actuator that applies force to a stage in a direction along a z-axis.

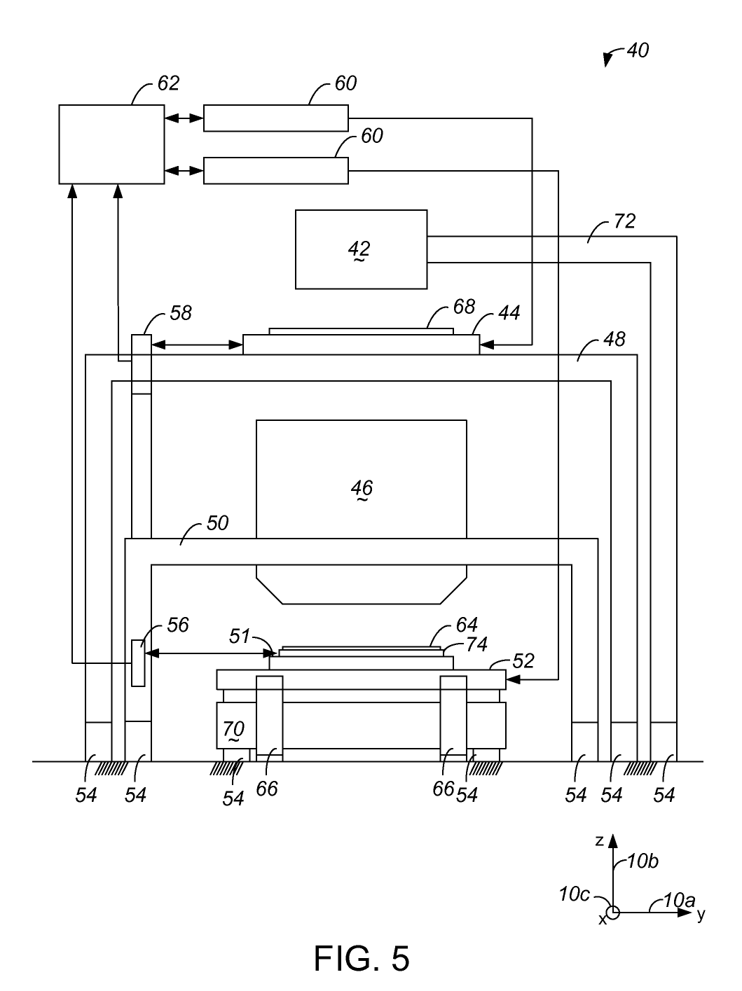

FIG. 4 is a diagrammatic representation of a duty cycle for a VCM that supports a stage of a stage apparatus that includes an antigravity or weight-canceller device in accordance with an embodiment. A duty cycle 436 for a VCM that applies a force along a z-axis indicates that when a stage is accelerating or stepping, e.g., approximately half of the time, a force generated by the VCM has a value 448 that is substantially equal to the vertical component of the force generated by actuators that provide a force that allows the stage to accelerate. When the stage is scanning, substantially no force is generated by the E-core actuator, and the force applied by the VCM has a value 444 that is substantially equal to the weight of the stage. In one embodiment, an antigravity setpoint 440 is set such that the force generated by the VCM is such that a heat load associated with the VCM is reduced. By way of example, in conventional systems, an antigravity setpoint may be equal to value 444 that balances stage weight such that during stepping, a VCM would produce a VCM force with a value of “2N” at approximately a 50% duty cycle. In one embodiment, a biased antigravity setpoint 440 results in the VCM force substantially alternating between “N” and “-N,” producing a force magnitude or absolute value of force of “N” at approximately a 100% duty cycle. As the heat associated with VCM actuators is typically proportional to a square of the magnitude of force, a heat savings, e.g., a heat savings of approximately 50%, may be achieved.

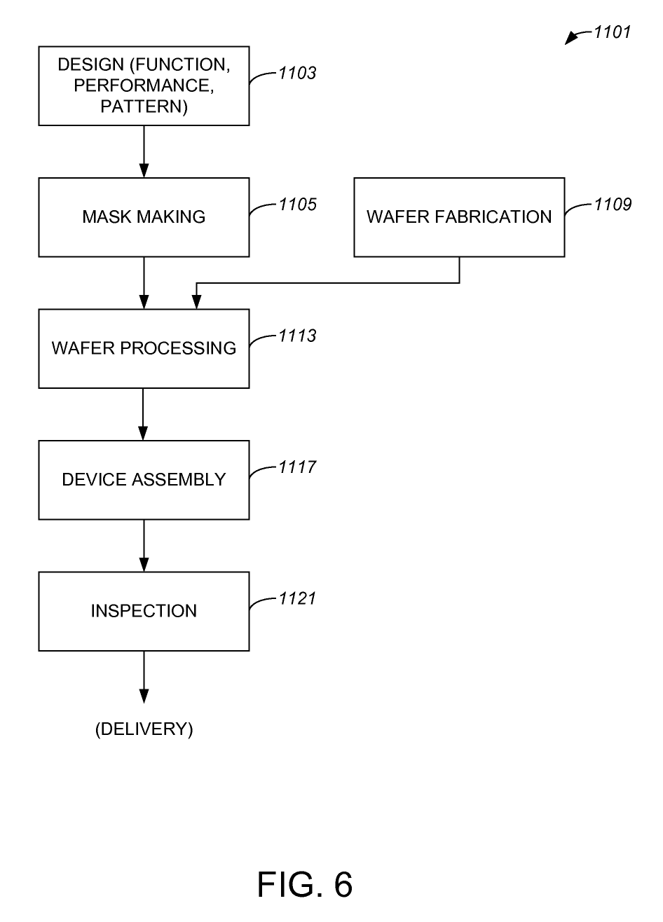

With reference to FIG. 5, a photolithography apparatus which may include actuators offset from a center of gravity of a stage and rotated to an angle that points through the center of gravity of the stage will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an E-core actuator. The planar motor which drives wafer positioning stage 52 generally uses an electromagnetic force generated by magnets and corresponding armature coils arranged in two dimensions.

A wafer 64 is held in place on a wafer holder or chuck 74 which is coupled to wafer table 51. Wafer positioning stage 52 is arranged to move in multiple degrees of freedom, e.g., in up to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, which may provide a beam of light that may be reflected off of a reticle. In one embodiment, illumination system 42 may be arranged to project a radiant energy, e.g., light, through a mask pattern on a reticle 68 that is supported by and scanned using a reticle stage 44 which may include a coarse stage and a fine stage, or which may be a single, monolithic stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser are used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave minor. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave minor, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

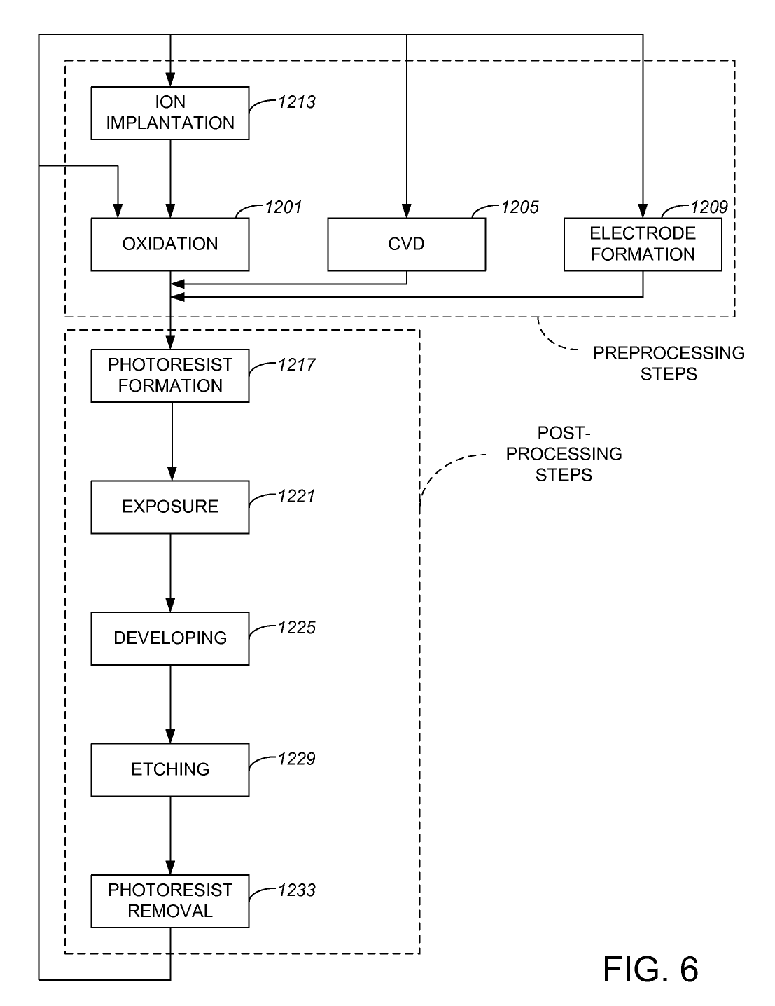

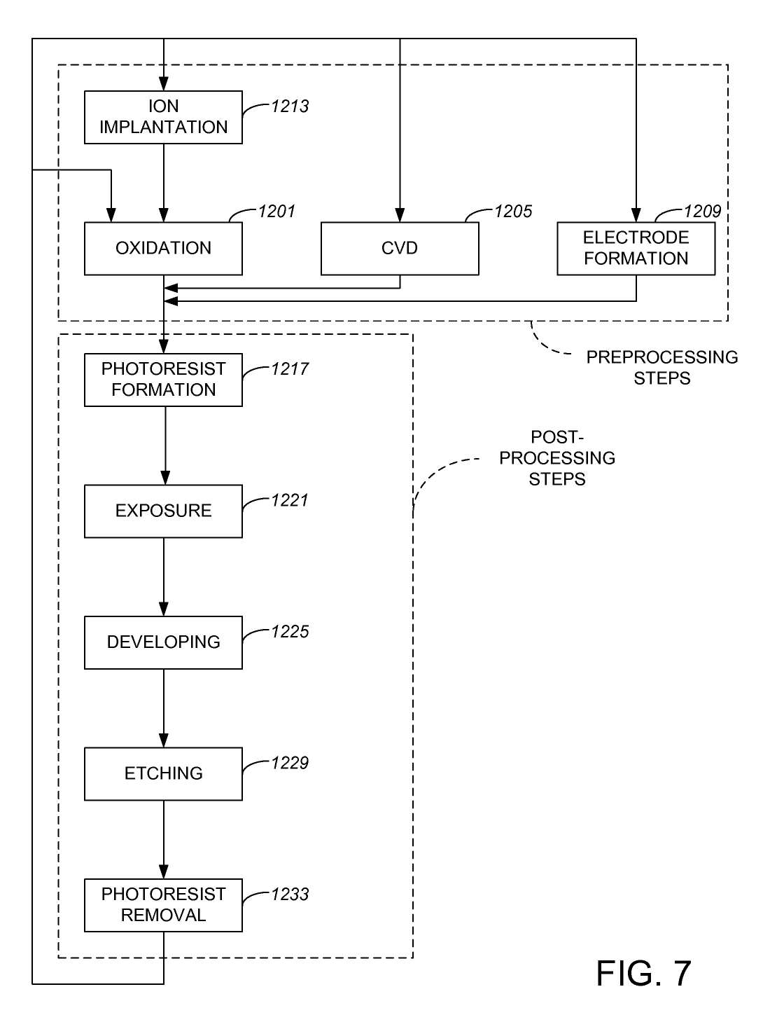

Further, semiconductor devices may be fabricated using systems described above, as will be discussed with reference to FIG. 6. FIG. 6 is a process flow diagram which illustrates the steps associated with fabricating a semiconductor device in accordance with an embodiment of the present invention. A process 1101 of fabricating a semiconductor device begins at step 1103 in which the function and performance characteristics of a semiconductor device are designed or otherwise determined. Next, in step 1105, a reticle or mask in which has a pattern is designed based upon the design of the semiconductor device. It should be appreciated that in a substantially parallel step 1109, a wafer is typically made from a silicon material. In step 1113, the mask pattern designed in step 1105 is exposed onto the wafer fabricated in step 1109. One process of exposing a mask pattern onto a wafer will be described below with respect to FIG. 7. In step 1117, the semiconductor device is assembled. The assembly of the semiconductor device generally includes, but is not limited to including, wafer dicing processes, bonding processes, and packaging processes. Finally, the completed device is inspected in step 1121. Upon successful completion of the inspection in step 1121, the completed device may be considered to be ready for delivery.

FIG. 7 is a process flow diagram which illustrates the steps associated with wafer processing in the case of fabricating semiconductor devices in accordance with an embodiment of the present invention. In step 1201, the surface of a wafer is oxidized. Then, in step 1205 which is a chemical vapor deposition (CVD) step in one embodiment, an insulation film may be formed on the wafer surface. Once the insulation film is formed, then in step 1209, electrodes are formed on the wafer by vapor deposition. Then, ions may be implanted in the wafer using substantially any suitable method in step 1213. As will be appreciated by those skilled in the art, steps 1201-1213 are generally considered to be preprocessing steps for wafers during wafer processing. Further, it should be understood that selections made in each step, e.g., the concentration of various chemicals to use in forming an insulation film in step 1205, may be made based upon processing requirements.

At each stage of wafer processing, when preprocessing steps have been completed, post-processing steps may be implemented. During post-processing, initially, in step 1217, photoresist is applied to a wafer. Then, in step 1221, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1225. Once the exposed wafer is developed, parts other than residual photoresist, e.g., the exposed material surface, may be removed by etching in step 1229. Finally, in step 1233, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present disclosure may be embodied in many other specific forms without departing from the spirit or the scope of the present disclosure. By way of example, the operations associated with the various methods of the present invention may vary widely. For instance, steps may be added, removed, altered, combined, and reordered without departing from the spirit or the scope of the present disclosure.

When the angles at which actuators are rotated with respect to an x-axis are relatively small, such as between approximately zero degrees and approximately twenty degrees, an amount of extra force that may be associated with the actuators due to the angles is relatively modest. The force generated by a support arrangement, e.g., a VCM force, may be expressed as an acceleration, e.g., an acceleration needed to drive a stage, scaled by a ratio of the vertical center of gravity mismatch such as z1 in FIG. 2. to the horizontal distance between an actuator and the center of gravity of the stage such as x1 in FIG. 2. The vertical center of gravity mismatch may be a distance between the center of gravity of the stage to a center of an actuator with respect to a z-axis, while the horizontal distance may be a distance with respect to an x-axis, or a y-axis, between the center of gravity of the stage and a center of the actuator.

Actuators such as E-core actuators or other variable-reluctance actuators, linear motors, planar motors, and VCMs have been described as being suitable for being offset from a stage center of gravity relative to a vertical axis, i.e., a z-axis. It should be understood, however, that actuators are not limited to being E-core actuators or other variable-reluctance actuators, linear motors, planar motors, and VCMs.

While actuators have been described as being arranged to drive a stage through a center of gravity of the stage such that the stage may move horizontally, such actuators are not limited to driving a stage such that the stage may move horizontally. For example, E-core actuators may be arranged to drive a stage through a center of gravity such that the stage may move vertically. That is, the present disclosure is not limited to being used with respect to a stage that is to move horizontally.

Actuators have generally been described as being offset from a center of gravity of a stage that the actuators are arranged to drive the stage through the center of gravity by generating a force applied at an angle relative to a horizontal axis. The offset has been described as a distance above or below the center of gravity. It should be appreciated that an actuator may be offset with respect to a center of gravity of a stage in any suitable direction, and that the direction may be determined based at least in part upon the direction in which the stage is to be driven by the actuator. For instance, if an actuator is arranged to drive a stage in a vertical direction, the actuator may be offset from a center of gravity of the stage to one side of the stage relative to a horizontal axis without departing from the spirit or the scope of the present invention.

The many features of the embodiments of the present invention are apparent from the written description. Further, since numerous modifications and changes will readily occur to those skilled in the art, the present disclosure should not be limited to the exact construction and operation as illustrated and described. Hence, all suitable modifications and equivalents may be resorted to as falling within the spirit or the scope of the present disclosure.

What is claimed is:

1. An apparatus comprising:
a stage, the stage having a stage center of gravity, wherein a first axis passes though the stage center of gravity;
a first actuator, the first actuator being configured to provide an overall force on the stage with a component parallel to the first axis, the first actuator being offset from the stage center of gravity relative to a second axis and arranged to generate a first force, the second axis being perpendicular to the first axis, wherein the first actuator is oriented to allow the first force to act through the stage center of gravity to drive the stage.

2. The apparatus of claim 1 further including:
a second actuator, the second actuator being offset from the stage center of gravity relative to the second axis and arranged to generate a second force, the second actuator being oriented to allow the second force to act through the stage center of gravity, wherein the first force and the second force cooperate to apply the overall force in the direction of the first axis on the stage.

3. The apparatus of claim 2 wherein the first force and the second force cooperate to drive the stage along the first axis.

4. The apparatus of claim 1 wherein the first actuator is one selected from a group including a variable-reluctance actuator, a voice coil motor, and a linear motor.

5. The apparatus of claim 1 further including:
a support arrangement, the support arrangement being configured to support the stage relative to the second axis.

6. The apparatus of claim 5 wherein the support arrangement is at least one selected from a group including a voice coil motor and a variable-reluctance actuator.

7. A stage apparatus comprising the apparatus of claim 1.

8. An exposure apparatus comprising the stage apparatus of claim 7

9. A wafer formed using the exposure apparatus of claim 8.

10. An apparatus comprising:
a stage, the stage being arranged to translate with respect to at least a first axis, wherein the stage has a center of gravity;
a first support arrangement, the first support arrangement being configured to support the stage with respect to a second axis; and
a first actuator, the first actuator being configured to drive the stage with respect to the at least first axis by applying a first actuator force through the center of gravity, wherein the first actuator force is applied at an angle with respect to the at least first axis.

11. The apparatus of claim 10 wherein the first axis is a horizontal axis and the second axis is a vertical axis.

12. The apparatus of claim 11 wherein the first support arrangement is further configured to cause the stage to translate with respect to the vertical axis.

13. The apparatus of claim 12 wherein the first support arrangement includes at least one selected from a group including a voice coil motor and a variable-reluctance actuator.

14. The apparatus of claim 10 wherein the first actuator is one selected from a group including a variable reluctance actuator, a voice coil motor, and a linear motor.

15. The apparatus of claim 10 wherein the first support arrangement is arranged to apply a force to the stage at a first location, the first location being a first distance from the center of gravity with respect to the at least first axis, and wherein the first actuator is positioned at a second distance from the center of gravity with respect to the at least first axis, the second distance being greater than the first distance.

16. A stage apparatus comprising the apparatus of claim 10.

17. An exposure apparatus comprising the stage apparatus of claim 16.

18. A wafer formed using the exposure apparatus of claim 17.

19. A method of driving a stage along a first axis using a first actuator, the stage having a stage center of gravity, the first actuator being offset from the stage center of gravity relative to a second axis, wherein a first force from the first actuator is applied to the stage through the stage center of gravity and at an angle with respect to the first axis by a support arrangement, the method comprising:
generating a first force, the first force being generated by the first actuator to drive the stage along the first axis, wherein the first force is applied to the stage through the stage center of gravity and at an angle with respect to the first axis; and
generating a second force, the second force being generated by the support arrangement, wherein the second force is applied to the stage along the second axis.

20. The method of claim 19 wherein the first actuator is a variable-reluctance actuator and the support arrangement includes at least one selected from a group including a voice coil motor and a variable-reluctance actuator.

21. The method of claim 19 wherein the first actuator is a voice coil motor and the support arrangement includes at least one selected from a group including a voice coil motor and a variable-reluctance actuator.

22. The method of claim 18 wherein the first actuator is offset from the stage center of gravity by a first distance relative to the second axis, and wherein the second force is a function of the first distance.
